(19) United States
(12) Patent Application Publication
(10) Pub. No.: US 2025/0376889 A1
(43) Pub. Date: Dec. 11, 2025

(54) Fenestration Units and Related Structural Frames

(71) Applicant: Frank Joseph Tortorella, JR., Park Ridge, IL (US)

(72) Inventor: Frank Joseph Tortorella, JR., Park Ridge, IL (US)

(21) Appl. No.: 19/222,886

(22) Filed: May 29, 2025

Related U.S. Application Data
(60) Provisional application No. 63/657,059, filed on Jun. 6, 2024.

(51) Int. Cl. E06B 1/36

(52) U.S. Cl. CPC E06B 1/36

(57) ABSTRACT

Fenestration units and related structural frames are disclosed. In an implementation, an apparatus includes a window frame and a structural frame. A window frame includes a head, a sill, a first jamb, and a second jamb. The first jamb and the second jamb are coupled to and extend between the head and the sill. The structural frame is coupled to the window frame, wherein the structural frame is configured to transfer vertical loads around a rough opening in which the window frame is to be installed.

### RELATED APPLICATION

This application claims the benefit of and priority to U.S. Provisional Patent Application No. 63/657,059, filed Jun. 6, 2024, the content of which is incorporated by reference herein in its entirety and for all purposes.

### FIELD OF THE DISCLOSURE

The present disclosure relates to structural frames and, more particularly, to fenestration units and related structural frames.

### BACKGROUND

Windows may be positioned within a rough opening of a structure.

### SUMMARY

Disclosed herein is a versatile load-bearing system designed to support and distribute structural loads above openings in buildings and other structures. The system is adaptable for on-site construction and manual assembly, ensuring compatibility with a variety of materials and structural configurations. The disclosed examples provide a comprehensive solution that enhances the structural integrity of openings, facilitating safe and effective load management. The disclosed system is applicable to any type of interior or exterior structural opening (e.g., a window opening, a door opening, a portal, a passageway, etc.) in a structure (e.g., a building, a residence, a commercial structure, etc.) requiring a load bearing header.

In accord with at least some aspects of the present concepts, a pre-engineered window unit comprises a header, a window sill plate, a first lateral stud element, and/or a second lateral stud element, in any combination. For instance, in various examples and without limitation, the pre-engineered window unit comprises only a header; a header and a first lateral stud element; a header and both a first lateral stud element and a second lateral stud element; all of a header, a first lateral stud element, a second lateral stud element, and a window sill plate; only a window sill plate; only a first lateral stud element; only a second lateral stud element; a first lateral stud element and a second lateral stud element; a window sill plate and a first lateral stud element; a window sill plate and both a first lateral stud element and a second lateral stud element. In at least some aspects, the pre-engineered window unit comprises a window pre-installed in or to the header, window sill plate, first lateral stud element, and/or second lateral stud element, in any combination.

In various aspects of the present concepts, the window associated with the pre-engineered window unit may comprise a single hung window, a double hung window, a slider window, a casement window, an awning window, a hopper window, a fixed window, a bay window, a bow window, a garden window, a picture window, a transom, a skylight, or a tilt and turn window.

In accord with at least some aspects of the present concepts, a pre-engineered door frame unit (or more generally a pre-engineered portal frame unit, which omits a door, or a pre-engineered passageway frame unit) is formed to include a header, a sole plate, a first lateral stud element, and/or a second lateral stud element, in any combination. For instance, in various examples and without limitation, the pre-engineered door frame unit is formed to include only a header; a header and a first lateral stud element; a header and both a first lateral stud element and a second lateral stud element; all of a header, a first lateral stud element, a second lateral stud element, and a door sole/sill plate; only a door sole/sill plate; only a first lateral stud element; only a second lateral stud element; a first lateral stud element and a second lateral stud element; a door sole/sill plate and a first lateral stud element; a door sole/sill plate and both a first lateral stud element and a second lateral stud element. In at least some aspects, the pre-engineered door frame unit comprises a door pre-installed, via door hardware (e.g., hinges, etc.), to the first lateral stud element and/or the second lateral stud element. In at least some aspects, the pre-engineered door frame unit comprises a door pre-installed, via door hardware (e.g., slider, etc.) in first lateral stud element and/or second lateral stud element.

In various aspects of the present concepts, the door associated with the pre-engineered door frame unit may comprise an interior door, an exterior door, or a garage door. In some aspects of the present concepts, the door (or partition) may comprise a hinged (single) door, a hinged (double) door, a sliding door, a folding (e.g., bi-fold) door, a pivot door, a Dutch door, a pocket door, a barn door, a revolving door, or an accordion door.

In some aspects, the pre-engineered window unit and/or the pre-engineered door frame unit are pre-engineered with a specified load rating for vertical loading through the header and the first and second lateral stud elements (e.g., jack studs) to facilitate ready selection of a compliant (e.g., consistent with local building codes and application, consistent with the International Building Code (IBC) requirements, International Residential Code (IRC) requirements, National Construction Code (NCC) requirements, state code requirements, locality code requirements, etc., as applicable, or equivalents thereof, etc.) pre-engineered window unit and/or the pre-engineered door frame unit from a plurality of available pre-engineered window units and/or pre-engineered door frame units with different load ratings (or ranges of load ratings).

In some aspects, the specified load rating for vertical loading through the header (e.g., X pounds per lineal foot, where X represents any value including, but not limited to, 500, 600, 700, 800, 900, 1000, 1100, 1200, 1300, 1400, 1500, 1600, 1700, 1800, 1900, 2000, or any value therebetween) and the first and second lateral stud elements (e.g., jack studs) comprises the sum of all live loads (e.g., environmental loads, such as wind loads from wind pressure differentials, occupant loads, furniture loads, etc.) and dead loads (e.g., structural loads of a constant magnitude over time such as the self-weight of structural members inclusive of the weight of the window itself, walls, ceilings, floors, beams, columns, roofs, etc.), including distributed and point loads, acting on the header (and lateral stud elements) without compromising the pre-engineered window unit's (or pre-engineered door unit's) structural integrity (e.g., ability to support the dead and live loads without deflection in excess of acceptable limits) or sealing (e.g., weatherproofing, etc.) under the various loading conditions. While the above example loadings through the header represent a range of typical values for header vertical loadings for conventional structures and conventional loadings for residential properties (e.g., based on the roof structure (e.g., configuration of rafters, ceiling joists, girder(s), ridge beams, etc.), number of floors, conventional materials of construction, etc.), the vertical loadings for which the pre-engineered window unit's (or pre-engineered door unit's) are designed can be higher, even significantly higher, for some residential properties or for industrial or commercial properties (which vary significantly in design from residential structures and which utilize different building materials including steel beams, reinforced concrete, etc.) and the value of “X pounds per lineal foot” noted above could be higher, or even significantly higher, than the example values specified above.

In accord with some aspects of the present concepts, a purchaser (e.g., a builder, a contractor, an end-user, etc.) can select a pre-engineered window unit (or pre-engineered door unit) having a desired load rating (e.g., 1000 pounds per lineal foot, or the like) or falling within a desired range of load ratings (e.g., 1000-1200 pounds per lineal foot, or the like) from a plurality of available pre-engineered window unit (or pre-engineered door unit) load ratings options.

Optionally, in some aspects of the present concepts, the pre-engineered window unit comprises cripple stud elements attached to, or integrally formed with, the header.

On installation of an example pre-engineered window unit, the first lateral stud element and the second lateral stud element are secured to respective king studs, the sill element is secured to the base plate, and the header is secured to cripple studs or top plate, or the like. While the order of securement of the various portions of the example pre-engineered window unit could be in any order, in accord with at least some aspects of a method of installation of the example pre-engineered window unit, the first portion of the pre-engineered window unit to be secured would be one of the first lateral stud element, the second lateral stud element, or the sill element, the second portion of securement would be another of the first lateral stud element, the second lateral stud element, or the sill element, and the third portion of securement would be the remaining one of the first lateral stud element, the second lateral stud element, or the sill element, with the fourth portion of securement being the securement of the header.

On installation of an example pre-engineered door unit (with extension to a pre-engineered portal unit or a pre-engineered passageway unit), the first lateral stud element and the second lateral stud element are secured to respective king studs, the sill (where provided for an exterior pre-engineered door unit) is secured to the base plate, and the header is secured to cripple studs or top plate, or the like. While the order of securement of the various portions of the example pre-engineered door unit could be in any order, in accord one example method of installation of the example pre-engineered window unit, the first portion of the pre-engineered window unit to be secured would be one of the first lateral stud element, the second lateral stud element, or the sill (where provided for an exterior pre-engineered door unit), the second portion of securement would be another of the first lateral stud element, the second lateral stud element, or the sill (where provided for an exterior pre-engineered door unit). In this example method, for an exterior pre-engineered door unit, a third portion of securement would be the remaining one of the first lateral stud element, the second lateral stud element, or the sill and the fourth portion of securement being the securement of the header. In this example method, for an interior pre-engineered door unit, a third portion of securement would be the securement of the header.

With respect to the above-noted pre-engineered window unit, the example pre-engineered door unit, pre-engineered portal unit or a pre-engineered passageway unit, or the like (collectively, “pre-engineered units” for brevity), the pre-engineered units are, in some aspects, fully assembled/manufactured/formed by the manufacturer, and are, in other aspects, assembled by hand (in whole or in part) on-site at the construction site from an assemblage of pre-made parts.

For instance, in one example, a method of forming a pre-engineered window unit may be performed at a manufacturing facility or, in other aspects, may be performed on-site by a worker who assembles one or more elements to a window frame prior to installation of the window frame in a window frame rough opening. Thus, in accord with some aspects of the present concepts, a method of forming a pre-engineered window unit comprises attaching a header to a head of a window frame prior to installation of the window frame in a window frame rough opening. The method may further include the acts of attaching a first lateral stud element to the header, attaching the first lateral stud element to a first jamb of the window frame, attaching a second lateral stud element to the header, and/or attaching the second lateral stud element to the second jamb of the window frame. In some aspects of the present concepts, one or more of these acts are performed prior to installation of the window frame in a window frame rough opening. The method may further include the act of attaching a sill element to a sill of the window frame, to the first lateral stud element, and to the second lateral stud element. In some aspects of the present concepts, this act is performed prior to installation of the window frame in a window frame rough opening.

In another example, a method of forming a pre-engineered door unit may be performed at a manufacturing facility or, in other aspects, may be performed on-site by a worker who assembles one or more elements to a door frame prior to installation of the door frame in a door frame rough opening. Thus, in accord with some aspects of the present concepts, a method of forming a pre-engineered door unit comprises attaching a header to a head of a door frame prior to installation of the door frame in a door frame rough opening. The method may further include the acts of attaching a first lateral stud element to the header, attaching the first lateral stud element to a first jamb of the door frame, attaching a second lateral stud element to the header, and/or attaching the second lateral stud element to the second jamb of the door frame. In some aspects of the present concepts, one or more of these acts are performed prior to installation of the door frame in a door frame rough opening. The method may further include the act of attaching a sill to the first lateral stud element and to the second lateral stud element. In some aspects of the present concepts, this act is performed prior to installation of the door frame in a door frame rough opening.

In any of the above examples, the relevant parts to attach to the respective window unit or door unit may be provided as a kit. In some examples, a kit for the window unit or door unit further includes a plurality of selectable parts for attachment and securement to the window frame or door frame (e.g., parts of differing materials, widths, lengths and/or depths) to facilitate adaptation of the window unit or door unit by the installer to unexpected variances, conditions, or errors in framing of the rough window opening or rough door opening.

The disclosed examples allow for building and installing a wall with a pre-engineered header and window system is around 2 hours, as an example. This timeline can vary based on factors such as complexity of the design, worker skill level, and availability of tools and materials. In contrast, traditional methods take round 10-12 hours.

In accord with the examples provided herein, it is to be understood that the present concepts can be extended to and method, apparatus or system to distribute and support structural loads above structural openings including, but not limited to doors, windows, portals and passageways. The structural units (e.g., window unit, door unit, etc.) may be manufactured, or may be assembled on-site, and may use modular components or prefabricated or customized parts, and may comprise various structural materials, such as wood, metal, concrete, and composite materials. The assembled structural unit is then integrated with existing structural elements to enhance load distribution and ensure structural integrity.

### BRIEF DESCRIPTION OF THE DRAWINGS

FIG. 1 is a front view of an example window in accordance with the teachings of this disclosure.

FIG. 2 is a front view of an example door in accordance with the teachings of this disclosure.

FIG. 3 is a front view of an example garage door system in accordance with the teachings of this disclosure.

### DETAILED DESCRIPTION

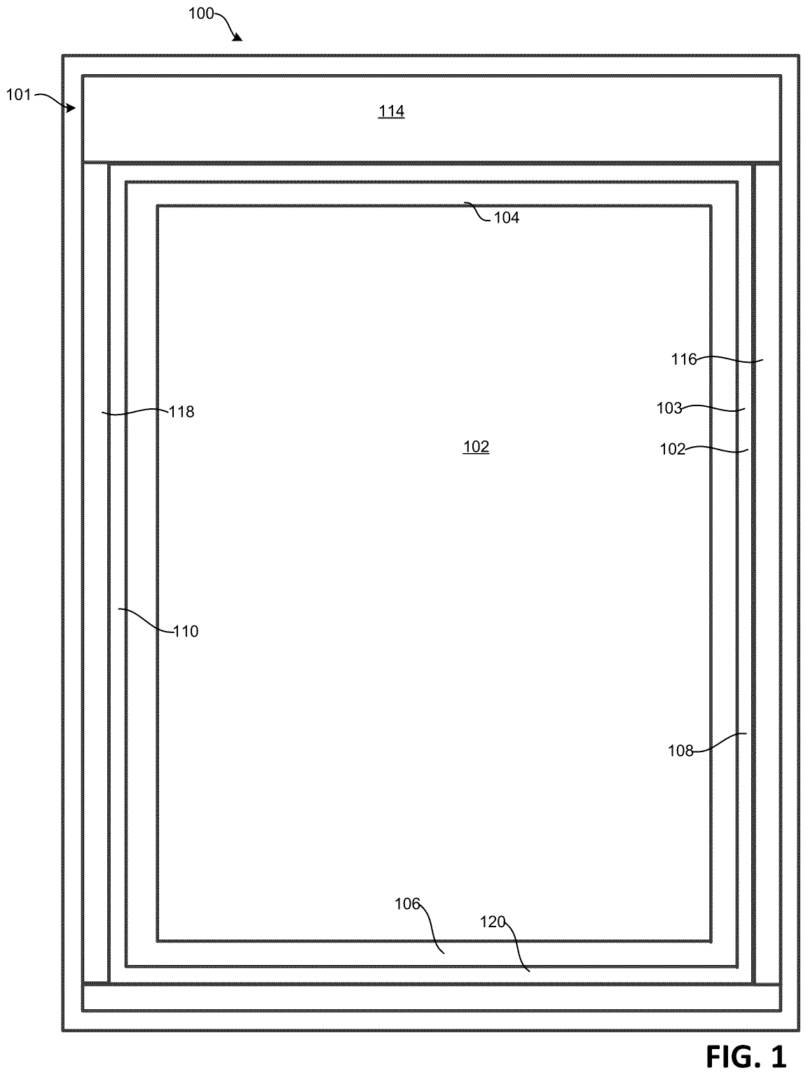

FIG. 1 is a front view of an example window 100 in accordance with the teachings of this disclosure. The window 100 may be an aluminum window, a single hung window, a double-hung window, a casement window, an awning window, a slider window, a picture window, a bay window, a bow window, a skylight window, a hopper window, and/or a utility slider window as examples.

The window 100 includes a window frame 102 and a structural frame 101 coupled to the window frame 102. The window frame 102 may be referred to as a fenestration unit 103.

The window frame 102 includes a head 104, a sill 106, a first jamb 108, and a second jamb 110. The first jamb 108 and the second jamb 110 are coupled to and extend between the head 104 and the sill 106. The structural frame 101 is configured to transfer vertical loads around a rough opening in which the window frame 102 is to be installed.

The structural frame 101 is configured to satisfy a threshold load rating value for vertical loading in some implementations. The threshold load rating value may be about 2000 pounds. The threshold load rating value may be between about 200 pounds and about 600 pounds, between about 300 pounds and about 800 pounds, about 500 pounds and about 1200 pounds, between about 700 pound and about 1800 pounds. As set forth herein the word “about” accounts for engineering tolerances and variations.

In the implementation shown, the structural fame 101 includes a header 114 coupled to the head 104 of the window frame 102. The header 114 and the head 104 of the window frame 102 are integral in some implementations. The structural frame 101 includes a first trimmer stud 116 and a second trimmer stud 118. The first trimmer stud 116 is coupled to the first jamb 108 and the header 114 and the second trimmer stud 118 is coupled to the second jamb and the header 114 in the implementation shown. The first trimmer stud 116 and second trimmer stud 118 may alternatively not be coupled to the header 114, the first trimmer stud 116, and/or the second trimmer stud 118. For example, the first trimmer stud 116 may be coupled to the header 114 and may not be coupled to the first jamb 108. The first trimmer stud 116 and the first jamb 108 may be integral and the second trimmer stud 118 and the second jamb 110 may be integral. The first trimmer stud 116 and/or the second trimmer stud 118 may be separate components coupled to the first jamb 108 and the second jamb 110. The first trimmer stud 116 and/or the second trimmer stud 118 may alternatively omitted.

The structural frame 101 includes a window sill plate 120 coupled to the sill 106, the first trimmer stud 116, and the second trimmer stud 118. The window sill plate 120 may alternatively not be coupled to the sill 106, the first trimmer stud 116, and/or the second trimmer stud 118. For example, the window sill plate 120 may be coupled to the first jamb 108 and/or the second jamb 110 and may not be coupled to the sill 106. The window sill plate 120 and the sill 106 may be integral. The header 114, the first trimmer stud 116, the second trimmer stud 118, and the window sill plate 120 may be integral. The window sill plate120 may alternatively be omitted.

The window frame 102 and/or the structural frame 101 may include at least one of metal, aluminum, plastic, a polymer, a composite, fiberglass, and/or wood. As an example, the window frame 102 and/or the structural frame 101 may include aluminum, a metal alloy, steel, a polymer, vinyl, a high-density polyethylene (HDPE), a composite material, wood and vinyl, and/or clad wood. Other materials may prove suitable.

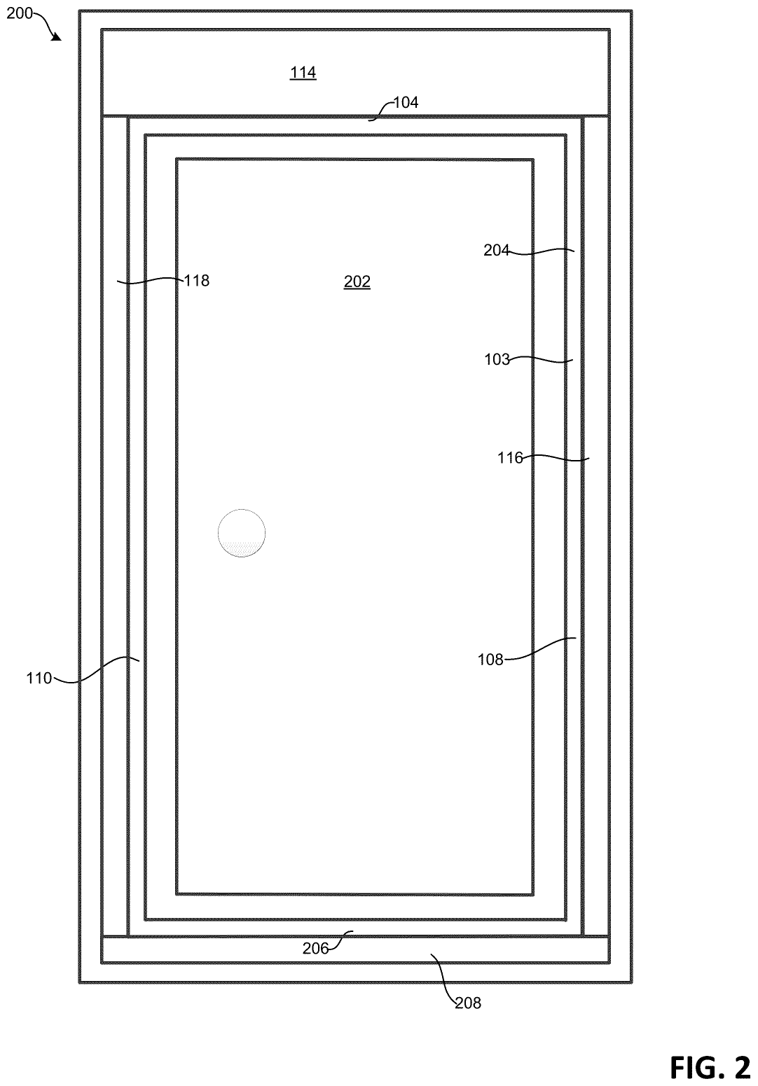

FIG. 2 is a front view of an example door 200 in accordance with the teachings of this disclosure. The door 200 includes a door panel 202 and a door frame 204 carrying the panel 202. The door frame 204 includes a door sill 206. The door panel 702 may alternatively be referred to as a door leaf. The structural frame 101 is shown coupled to the door frame 204 and includes a door sill plate 208.

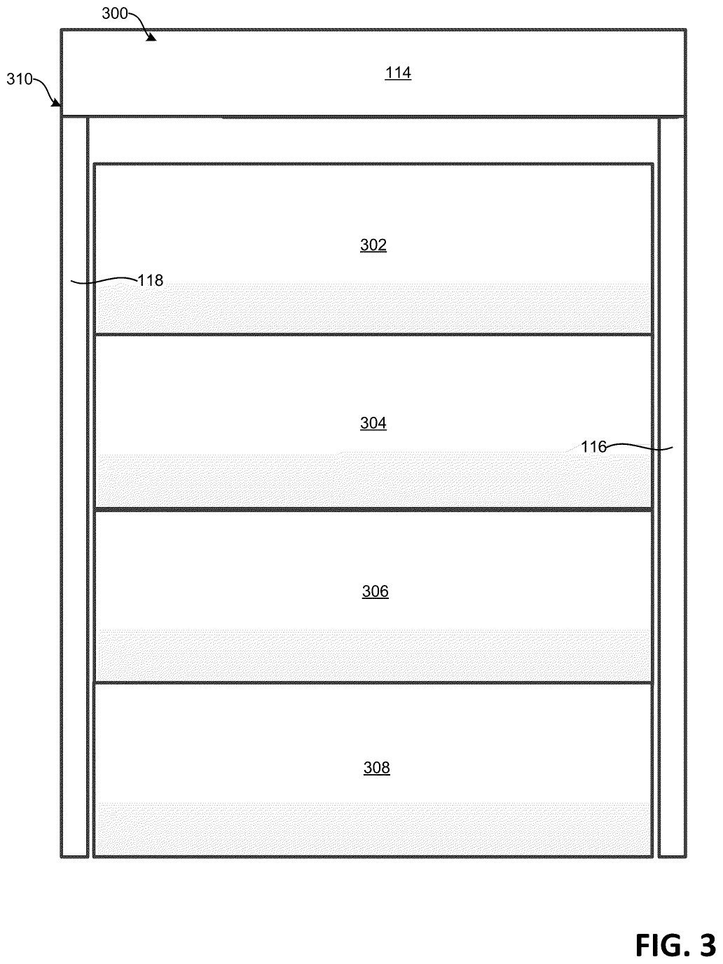

FIG. 3 is a front view of an example garage door system 300 in accordance with the teachings of this disclosure. The garage door system 300 includes a plurality of door sections 302, 304, 306, 308 and a structural frame 310 coupled to the door sections 302, 304, 306, 308. The structural frame 310 may be coupled to the door sections 302, 304, 306, 38 by a track system. The door sections 302, 304, 306, 308 may be hingably coupled together by hinges. The structural frame 310 is shown including the header 11, the first trimmer stud 116, and the second trimmer stud 118.

### Examples of Combinations:

Example 1. An apparatus, comprising: a window frame, comprising a head, a sill, a first jamb, and a second jamb, the first jamb and the second jamb coupled to and extending between the head and the sill; and a structural frame coupled to the window frame, wherein the structural frame is configured to transfer vertical loads around a rough opening in which the window frame is to be installed.

Example 2. The apparatus of Example 1, wherein the structural frame is configured to satisfy a threshold load rating value for vertical loading.

Example 3. The apparatus of Example 2, wherein the threshold load rating value comprises about 2000 pounds.

Example 4. The apparatus of Example 1, wherein the structural frame comprises a header coupled to the head of the window frame.

Example 5. The apparatus of Example 4, wherein the header and the head of the window frame are integral.

Example 6. The apparatus of Example 5, wherein the structural frame comprises a first trimmer stud and a second trimmer stud, the first trimmer stud coupled to the first jamb and the header and the second trimmer stud coupled to the second jamb and the header.

Example 7. The apparatus of Example 6, wherein the first trimmer stud and the first jamb are integral and wherein the second trimmer stud and the second jamb are integral.

Example 8. The apparatus of Example 6, wherein the structural frame comprises a window sill plate coupled to the sill, the first trimmer stud, and the second trimmer stud.

Example 9. The apparatus of Example 8, wherein the window sill plate and the sill are integral.

Example 10. The apparatus of Example 1, wherein at least one of the window frame or the structural frame comprises at least one of metal, aluminum, plastic, a polymer, a composite, fiberglass, or wood.

Example 11. An apparatus, comprising: a fenestration unit, comprising a head, a sill, a first jamb, and a second jamb, the first jamb and the second jamb coupled to and extending between the head and the sill; and a structural frame coupled to the fenestration unit, wherein the structural frame is configured to transfer vertical loads around a rough opening in which the fenestration unit is to be installed.

Example 12. The apparatus of Example 11, wherein the fenestration unit comprises a door panel and a door frame carrying the door panel.

Example 13. The apparatus of Example 11, wherein the fenestration unit comprises a window pane and a window frame carrying the window pane.

Example 14. The apparatus of Example 13, wherein the structural frame comprises a header coupled to the head of the window frame.

Example 15. The apparatus of Example 14, wherein the structural frame comprises a first trimmer stud and a second trimmer stud, the first trimmer stud coupled to the header and the second trimmer stud coupled to the header.

Example 16. The apparatus of Example 15, wherein the structural frame comprises a window sill plate coupled to the first trimmer stud and second trimmer stud.

Example 17. The apparatus of Example 16, wherein the header, the first trimmer stud, the second trimmer stud, and the window sill plate are integral.

Example 18. The apparatus of Example 11, wherein the structural frame comprises a first trimmer stud and a second trimmer stud, the first trimmer stud coupled to the first jamb and the second trimmer stud coupled to the second jamb.

Example 19. An apparatus, comprising: a fenestration unit, comprising a head, a first jamb, and a second jamb, the first jamb and the second jamb coupled to and extending from the head; and a header coupled to the fenestration unit, wherein the header is configured to transfer vertical loads around a rough opening in which the fenestration unit is to be installed.

Example 20. The apparatus of Example 19, wherein the fenestration unit comprises a) a door panel and a door frame carrying the door panel, b) a window pane and a window frame carrying the window pane, or c) a garage door system.

Example 21. A pre-engineered window unit, comprising: a window comprising a window frame, the window frame comprising a head, a first jamb, a second jamb, and a sill; and a header attached to the head of the window frame.

Example 22. The pre-engineered window unit of Example 21, further comprising a first lateral stud element attached to the header and extending along the first jamb.

Example 23. The pre-engineered window unit of Example 22, wherein a first side of the first lateral stud element is attached to the header and a second side of the first lateral stud element is attached to the first jamb

Example 24. The pre-engineered window unit of Example 23, further comprising a second lateral stud element attached to the header and extending along the second jamb.

Example 25. The pre-engineered window unit of Example 24, wherein a first side of the second lateral stud element is attached to the header and a second side of the second lateral stud element is attached to the second jamb.

Example 26. The pre-engineered window unit of Example 25, further comprising a sill element attached to a third side of the first lateral stud element and to a third side of the second lateral stud element, the sill element extending along the window sill.

Example 27. The pre-engineered window unit of Example 26, wherein the sill element is attached to the window sill.

Example 28. The pre-engineered window unit of any of Examples 21-27, wherein any one or more of the head, the first jamb, the second jamb, the sill, the header, the first lateral stud element, the second lateral stud element, and/or the sill element, in any combination, are formed from one or more of aluminum, a metal alloy (e.g., steel, etc.), a polymer (e.g., vinyl, high-density polyethylene (HDPE), etc.), a composite material (e.g., wood and vinyl, clad wood, etc.), fiberglass, and/or wood.

Example 29. The pre-engineered window unit of any of Examples 21-28, wherein all of the head, the first jamb, the second jamb, and the sill are formed from one of aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood.

Example 30. The pre-engineered window unit of any of Examples 21-29, wherein all of the head, the first jamb, the second jamb, the sill, the header, the first lateral stud element, the second lateral stud element, and the sill element, are formed from one of aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood.

Example 31. The pre-engineered window unit of any of Examples 21-30, wherein the head, the first jamb, the second jamb, and the sill are formed from a first material selected from aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood, and wherein the header, the first lateral stud element, the second lateral stud element, and the sill element, are formed from a second material, different than the first material, selected from aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood.

Example 32. The pre-engineered window unit of any of Examples 21-30, wherein the header is integrally formed with the head of the window frame.

Example 33. The pre-engineered window unit of any of Examples 21-30 or Example 32, wherein the sill element is integrally formed with the window sill of the window frame.

Example 34. The pre-engineered window unit of any of Examples 21-30 or Examples 32-33, wherein the first lateral stud element is integrally formed with the header, the first jamb, or the sill element, or is integrally formed with any combination of, or all of, the header, the first jamb, and/or the sill element.

Example 35. The pre-engineered window unit of any of Examples 21-30 or Examples 32-34, wherein the second lateral stud element is integrally formed with the header, the second jamb, or the sill element, or is integrally formed with any combination of, or all of, the header, the second jamb, and/or the sill element.

Example 36. The pre-engineered window unit of any of Examples 2-35, wherein the pre-engineered window unit is configured to meet or exceed a predetermined load rating for vertical loading.

Example 37. A pre-engineered door unit, comprising: a door frame comprising a head, a first jamb, and a second jamb; and a header attached to the head of the door frame.

Example 38. The pre-engineered window unit of Example 37, further comprising a first lateral stud element attached to the header and extending along the first jamb.

Example 39. The pre-engineered door unit of Example 38, wherein a first side of the first lateral stud element is attached to the header and a second side of the first lateral stud element is attached to the first jamb.

Example 40. The pre-engineered door unit of Example 39, further comprising a second lateral stud element attached to the header and extending along the second jamb.

Example 41. The pre-engineered door unit of Example 40, wherein a first side of the second lateral stud element is attached to the header and a second side of the second lateral stud element is attached to the second jamb.

Example 42. The pre-engineered door unit of Example 41, wherein the door frame further comprises a sill.

Example 43. The pre-engineered door unit of Example 42, further comprising a sill element, extending along the sill, attached to a third side of the first lateral stud element, a third side of the second lateral stud element, and the sill.

Example 44. The pre-engineered door unit of any of Examples 27-43, wherein any one or more of the head, the first jamb, the second jamb, the sill, the header, the first lateral stud element, the second lateral stud element, and/or the sill element, in any combination, are formed from one or more of aluminum, a metal alloy (e.g., steel, etc.), a polymer (e.g., vinyl, high-density polyethylene (HDPE), etc.), a composite material (e.g., wood and vinyl, clad wood, etc.), fiberglass, and/or wood.

Example 45. The pre-engineered door unit of any of Examples 37-44, wherein all of the head, the first jamb, the second jamb, and the sill are formed from one of aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood.

Example 46. The pre-engineered door unit of any of Examples 37-45, wherein all of the head, the first jamb, the second jamb, the sill, the header, the first lateral stud element, the second lateral stud element, and the sill element, are formed from one of aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood.

Example 47. The pre-engineered door unit of any of Examples 37-46, wherein the head, the first jamb, the second jamb, and the sill are formed from a first material selected from aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood, and wherein the header, the first lateral stud element, the second lateral stud element, and the sill element, are formed from a second material, different than the first material, selected from aluminum, a metal alloy (e.g., steel, etc.), a polymer (e.g., vinyl, high-density polyethylene (HDPE), etc.), a composite material (e.g., wood and vinyl, clad wood, etc.), fiberglass, or wood.

Example 48. The pre-engineered door unit of any of Examples 37-46, wherein the header is integrally formed with the head of the door frame.

Example 49. The pre-engineered door unit of any of Examples 37-46 or Example 48, wherein the sill element is integrally formed with the sill of the door frame.

Example 50. The pre-engineered door unit of any of Examples 37-46 or Examples 48-49, wherein the first lateral stud element is integrally formed with the header, the first jamb, or the sill element, or is integrally formed with any combination of, or all of, the header, the first jamb, and/or the sill element.

Example 51. The pre-engineered door unit of any of Examples 37-46 or Examples 48-50, wherein the second lateral stud element is integrally formed with the header, the second jamb, or the sill element, or is integrally formed with any combination of, or all of, the header, the second jamb, and/or the sill element.

Example 52. The pre-engineered door unit of any of Examples 37-51, wherein the pre-engineered door unit is configured to meet or exceed a predetermined load rating for vertical loading.

Example 53. A method of installing a pre-engineered window unit, comprising: providing a pre-engineered window unit according to the pre-engineered window unit of any of Examples 20-36; securing the first lateral stud element of the pre-engineered window unit to a first king stud of a rough window opening; securing the second lateral stud element of the pre-engineered window unit to a second king stud of the rough window opening; and securing the sill element of the pre-engineered window unit to a window sill plate or base plate.

Example 54. The method of installing a pre-engineered window unit according to Example 53, further comprising securing the header of the pre-engineered window unit to a plurality of cripple studs or a top plate.

Example 55. The method of installing a pre-engineered window unit according to Example 53 or Example 54, wherein the act of securing comprises using mechanical fasteners to effect the securement of the respective elements.

Example 56. The method of installing a pre-engineered window unit according to Example 55, wherein the mechanical fasteners comprise screws or nails.

Example 57. A method of installing a pre-engineered door unit, comprising: providing a pre-engineered door unit according to the pre-engineered door unit of any of Examples 37-52; securing the first lateral stud element of the pre-engineered door unit to a first king stud of a rough door opening; and securing the second lateral stud element of the pre-engineered door unit to a second king stud of the rough door opening.

Example 58. The method of installing a pre-engineered door unit according to Example 57, further comprising securing the sill element of the pre-engineered door unit to a sill plate, base plate, or subfloor.

Example 59. The method of installing a pre-engineered door unit according to Example 57 or Example 58, further comprising securing the header of the pre-engineered door unit to a plurality of cripple studs or a top plate.

Example 60. The method of installing a pre-engineered door unit according to any of Examples 57-59, wherein the act of securing comprises using mechanical fasteners to effect the securement of the respective elements.

Example 61. The method of installing a pre-engineered door unit according to Example 60, wherein the mechanical fasteners comprise screws or nails.

Example 62. A method of forming a pre-engineered window unit, comprising: attaching a header to a head of a window frame prior to installation of the window frame in a window frame rough opening.

Example 63. The method of forming a pre-engineered window unit according to Example 62, further comprising: attaching a first lateral stud element to the header.

Example 64. The method of forming a pre-engineered window unit according to Example 62 or Example 63, further comprising: attaching the first lateral stud element to a first jamb of the window frame.

Example 65. The method of forming a pre-engineered window unit according to any of Examples 62-64, further comprising: attaching a second lateral stud element to the header.

Example 66. The method of forming a pre-engineered window unit according to any of Examples 62-65, further comprising: attaching the second lateral stud element to the second jamb of the window frame.

Example 67. The method of forming a pre-engineered window unit according to any of Examples 62-66, further comprising: attaching a sill element to a sill of the window frame, to the first lateral stud element, and to the second lateral stud element.

Example 68. The method of forming a pre-engineered window unit according to any of Examples 62-67, wherein the attaching is performed via a mechanical fastener.

Example 69. The method of forming a pre-engineered window unit according to any of Examples 62-68, wherein the mechanical fastener comprises a screw or a nail.

Example 70. The method of forming a pre-engineered window unit according to any of Examples 62-69, wherein one or more of the acts of attaching the first lateral stud element to the header, attaching the first lateral stud element to the first jamb of the window frame, attaching the second lateral stud element to the header, attaching the second lateral stud element to the header, attaching the second lateral stud element to the second jamb of the window frame, and attaching the sill element to the sill of the window frame, to the first lateral stud element, and to the second lateral stud element, are performed prior to installation of the window frame in a window frame rough opening.

Example 71. The method of forming a pre-engineered window unit according to Example 70, wherein all of the acts of attaching the first lateral stud element to the header, attaching the first lateral stud element to the first jamb of the window frame, attaching the second lateral stud element to the header, attaching the second lateral stud element to the header, attaching the second lateral stud element to the second jamb of the window frame, and attaching the sill element to the sill of the window frame, to the first lateral stud element, and to the second lateral stud element, are performed prior to installation of the window frame in a window frame rough opening.

Example 72. A method of forming a pre-engineered door unit, comprising: attaching a header to a head of a door frame prior to installation of the door frame in a door frame rough opening.

Example 73. The method of forming a pre-engineered door unit according to Example 72, further comprising: attaching a first lateral stud element to the header.

Example 74. The method of forming a pre-engineered door unit according to Example 72 or Example 73, further comprising: attaching the first lateral stud element to a first jamb of the door frame.

Example 75. The method of forming a pre-engineered door unit according to any of Examples 72-74, further comprising: attaching a second lateral stud element to the header.

Example 76. The method of forming a pre-engineered door unit according to any of Examples 72-75, further comprising: attaching the second lateral stud element to a second jamb of the door frame.

Example 78. The method of forming a pre-engineered door unit according to any of Examples 72-77, further comprising: attaching a sill to the first lateral stud element and to the second lateral stud element.

Example 79. The method of forming a pre-engineered door unit according to any of Examples 72-78, wherein the attaching is performed via a mechanical fastener.

Example 80. The method of forming a pre-engineered door unit according to Example 79, wherein the mechanical fastener comprises a screw or a nail.

Example 81. The method of forming a pre-engineered door unit according to any of Examples 72-80, wherein one or more of the acts of attaching the first lateral stud element to the header, attaching the first lateral stud element to the first jamb of the door frame, attaching the second lateral stud element to the header, attaching the second lateral stud element to the header, attaching the second lateral stud element to the second jamb of the door frame, and attaching the sill to the first lateral stud element and to the second lateral stud element, are performed prior to installation of the door frame in a door frame rough opening.

Example 82. The method of forming a pre-engineered door unit according to Example 81, wherein all of the acts of attaching the first lateral stud element to the header, attaching the first lateral stud element to the first jamb of the door frame, attaching the second lateral stud element to the header, attaching the second lateral stud element to the header, attaching the second lateral stud element to the second jamb of the door frame, and attaching the sill to the first lateral stud element and to the second lateral stud element, are performed prior to installation of the door frame in a door frame rough opening.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The following claims recite aspects of certain examples of the disclosed subject matter and are considered to be part of the above disclosure. These aspects may be combined with one another.

What is claimed:

1. An apparatus, comprising:
a window frame, comprising a head, a sill, a first jamb, and a second jamb, the first jamb and the second jamb coupled to and extending between the head and the sill; and
a structural frame coupled to the window frame,
wherein the structural frame is configured to transfer vertical loads around a rough opening in which the window frame is to be installed.

2. The apparatus of claim 1, wherein the structural frame is configured to satisfy a threshold load rating value for vertical loading.

3. The apparatus of claim 2, wherein the threshold load rating value comprises about 2000 pounds.

4. The apparatus of claim 1, wherein the structural frame comprises a header coupled to the head of the window frame.

5. The apparatus of claim 4, wherein the header and the head of the window frame are integral.

6. The apparatus of claim 5, wherein the structural frame comprises a first trimmer stud and a second trimmer stud, the first trimmer stud coupled to the first jamb and the header and the second trimmer stud coupled to the second jamb and the header.

7. The apparatus of claim 6, wherein the first trimmer stud and the first jamb are integral and wherein the second trimmer stud and the second jamb are integral.

8. The apparatus of claim 6, wherein the structural frame comprises a window sill plate coupled to the sill, the first trimmer stud, and the second trimmer stud.

9. The apparatus of claim 8, wherein the window sill plate and the sill are integral.

10. The apparatus of claim 1, wherein at least one of the window frame or the structural frame comprises at least one of metal, aluminum, plastic, a polymer, a composite, fiberglass, or wood.

11. An apparatus, comprising:
a fenestration unit, comprising a head, a sill, a first jamb, and a second jamb, the first jamb and the second jamb coupled to and extending between the head and the sill; and
a structural frame coupled to the fenestration unit,
wherein the structural frame is configured to transfer vertical loads around a rough opening in which the fenestration unit is to be installed.

12. The apparatus of claim 11, wherein the fenestration unit comprises a door panel and a door frame carrying the door panel.

13. The apparatus of claim 11, wherein the fenestration unit comprises a window pane and a window frame carrying the window pane.

14. The apparatus of claim 13, wherein the structural frame comprises a header coupled to the head of the window frame.

15. The apparatus of claim 14, wherein the structural frame comprises a first trimmer stud and a second trimmer stud, the first trimmer stud coupled to the header and the second trimmer stud coupled to the header.

16. The apparatus of claim 15, wherein the structural frame comprises a window sill plate coupled to the first trimmer stud and second trimmer stud.

17. The apparatus of claim 16, wherein the header, the first trimmer stud, the second trimmer stud, and the window sill plate are integral.

18. The apparatus of claim 11, wherein the structural frame comprises a first trimmer stud and a second trimmer stud, the first trimmer stud coupled to the first jamb and the second trimmer stud coupled to the second jamb.

19. An apparatus, comprising:
a fenestration unit, comprising a head, a first jamb, and a second jamb, the first jamb and the second jamb coupled to and extending from the head; and
a header coupled to the fenestration unit,
wherein the header is configured to transfer vertical loads around a rough opening in which the fenestration assembly is to be installed.

20. The apparatus of claim 19, wherein the fenestration unit comprises a) a door panel and a door frame carrying the door panel b) a window pane and a window frame carrying the window pane, or c) a garage door system.
